(19) United States
(12) Patent Application Publication
(10) Pub. No.: US 2019/0306055 A1
(43) Pub. Date: Oct. 3, 2019

(54) EFFICIENT AND RELIABLE MESSAGE CHANNEL BETWEEN A HOST SYSTEM AND AN INTEGRATED CIRCUIT ACCELERATION SYSTEM

(71) Applicant: ALIBABA GROUP HOLDING LIMITED, George Town (KY)

(72) Inventor: Xiaowei Jiang, San Mateo, CA (US)

(73) Assignee: ALIBABA GROUP HOLDING LIMITED

(21) Appl. No.: 15/940,885

(22) Filed: Mar. 29, 2018

(51) Int. Cl. H04L 12/721; H04L 29/08

(52) U.S. Cl. CPC H04L 45/566; H04L 29/08027

(57) ABSTRACT

Embodiments of the present disclosure provide an integrated circuit including a chip processor, a memory, a peripheral interface configured to communicate with a host system comprising a host processor, and a message forwarding engine configured to acquire a data packet and to encapsulate the data packet with header information indicating that the acquired data packet is being communicated between the chip processor and the host processor.

### BACKGROUND

Today's data centers are deployed with workloads that demand massive amounts of data-level parallelism, such as machine learning, deep learning, and cloud computing workloads, among others. Another type of workload that consumes a large fraction of computing resources in a cloud data center is the software layer that handles network packet processing and backend storage. These workloads have promoted a need for hardware accelerators.

Hardware accelerators can offload code that is not performance-optimal to run on a host CPU of a computing device such as a laptop, desktop, server, cellular devices, and the like, thereby freeing up the host CPU's resources. Because the freed-up CPU resources can be sold as extra virtual machines to cloud customers, it is beneficial for cloud service providers in terms of operating expense (OPEX). A hardware accelerator also has a dedicated hardware acceleration engine that provides high data parallelism or provides specialized hardware implementation of a software algorithm.

While this offloading frees up the host CPU's resources, conventional hardware accelerators are quite limited in that they can only carry messages that are small in size, such as battery information, alert of thermal events, and fan speed. Accordingly, conventional hardware accelerators are not suited to transfer large amounts of data in a timely, reliable, and efficient manner.

### SUMMARY

Embodiments of the present disclosure provide a processing system and a method for an efficient and reliable message channel between a host CPU and an integrated circuit CPU. The embodiments encapsulate messages in Ethernet packets by leveraging a kernel TCP/IP networking stack to ensure reliable transfer of data and use a hardware message forwarding engine to transfer the packets between the host CPU and the integrated circuit subsystem's CPU efficiently, regardless of size of the data.

Embodiments of the present disclosure also provide an integrated circuit comprising a chip processor, a memory, a peripheral interface configured to communicate with a host system comprising a host processor, and a message forwarding engine configured to acquire a data packet and to encapsulate the data packet with header information indicating that the acquired data packet is being communicated between the chip processor and the host processor.

The memory is configured to store the encapsulated data packet, and wherein the message forwarding engine further comprises a frame check processing engine configured to determine a frame check sequence of the acquired data packet, wherein the frame check sequence is attached to the encapsulated data packet. The encapsulated data packet includes a field of the header information, wherein the field indicates that the acquired data packet is being communicated between the chip processor and the host processor, a payload having the acquired data packet, and the frame check sequence after the payload

The message forwarding engine is further configured to trigger an interrupt to the chip processor, wherein the interrupt is configured to cause a device driver of the chip processor to access the encapsulated data packet from the memory, and wherein the chip processor is configured to determine whether the encapsulated data packet includes header information indicating that the acquired data packet is being communicated between the chip processor and the host processor. The chip processor is configured to determine whether the encapsulated data packet includes header information indicating that the acquired data packet is being communicated between the chip processor and the host processor and is further configured to decapsulate the encapsulated data packet when the encapsulated data packet includes the header information.

The message forwarding engine further comprises a ring buffer configured to receive, via the peripheral interface, an address of the data packet from a host system, wherein the address is used by the message forwarding engine to acquire the data packet from the host system, and wherein the ring buffer is further configured to store an address within the memory where the encapsulated data packet is stored.

Embodiments of the present disclosure also provide a server comprising a host system having a host processor and an integrated circuit comprising a chip processor, a memory, a peripheral interface configured to communicate with the host processor, and a message forwarding engine configured to acquire a data packet and to encapsulate the data packet with header information indicating that the acquired data packet is being communicated between the chip processor and the host processor.

The message forwarding engine further comprises a frame check processing engine configured to determine a frame check sequence of the acquired data packet, wherein the frame check sequence is attached to the encapsulated data packet, and a frame check processing engine configured to determine a frame check sequence of the acquired data packet, wherein the frame check sequence is attached to the encapsulated data packet.

The chip processor is configured to determine whether the encapsulated data packet includes header information indicating that the acquired data packet is being communicated between the chip processor and the host processor and to decapsulate the encapsulated data packet when the encapsulated data packet includes the header information.

The message forwarding engine further comprises a ring buffer configured to receive, via the peripheral interface, an address of the data packet from a host system, wherein the address is used by the message forwarding engine to acquire the data packet from the host system, and to store an address within the memory where the encapsulated data packet is stored.

Embodiments of the present disclosure also provide a method performed by an integrated circuit having a chip processor, wherein the integrated circuit is communicatively coupled to a host system having a host processor, the method comprising acquiring, from a sending processor, one or more data packets intended for a receiving processor, wherein the sending processor is one of the chip processor and the host processor and the receiving processor is the other of the chip processor and the host processor, encapsulating the one or more acquired data packets with header information indicating that the acquired data packet is being communicated between the chip processor and the host processor, storing the one or more encapsulated data packets in the memory of the integrated circuit, and delivering an interrupt to the receiving processor, wherein the interrupt provides information that causes the receiving processor to acquire the encapsulated one or more data packets from the memory.

The one or more encapsulated data packets includes a frame check sequence for verifying the acquired data packet.

Embodiments of the present disclosure also provide a method performed by a receiving processor that is one of host processor of a host system and a chip processor of an integrated circuit that is communicatively coupled to the host system, the method comprising acquiring one or more data packets from a memory of the integrated circuit, determining whether the one or more acquired data packets includes additional header information indicating that that the acquired data packet is being communicated between the host processor and the chip processor, decapsulating the header information of the one or more data packets in response to the one or more acquired data packets having the additional header information, and processing the payload of the one or more acquired data packets.

The method further comprising prior to acquiring the one or more data packets, receiving an interrupt configured to cause the receiving processor to call for the one or more data packets from the memory, and wherein processing the payload of the one or more acquired data packets occurs when a frame check sequence corresponds to the payload of the one or more acquired data packets.

Additional objects and advantages of the disclosed embodiments will be set forth in part in the following description, and in part will be apparent from the description, or may be learned by practice of the embodiments. The objects and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 illustrates a block diagram of an exemplary integrated circuit.

FIG. 2 a schematic diagram of a client-server system that includes an exemplary integrated circuit, consistent with embodiments of the present disclosure.

FIG. 3 illustrates a block diagram of an integrated circuit comprising a message forwarding engine, consistent with embodiments of the present disclosure.

FIG. 4 illustrates a block diagram of an exemplary message forwarding engine, consistent with embodiments of the present disclosure.

FIG. 5 illustrates a block diagram of exemplary operational steps when a host processor and an integrated circuit processor communicate data with each other, consistent with embodiments of the present disclosure.

FIG. 6 illustrates a flowchart of an exemplary method for acquiring and encapsulating data packets, consistent with embodiments of the present disclosure.

FIG. 7 illustrates a flowchart of an exemplary method for acquiring and decapsulating data packets, consistent with embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of systems and methods consistent with aspects related to the invention as recited in the appended claims.

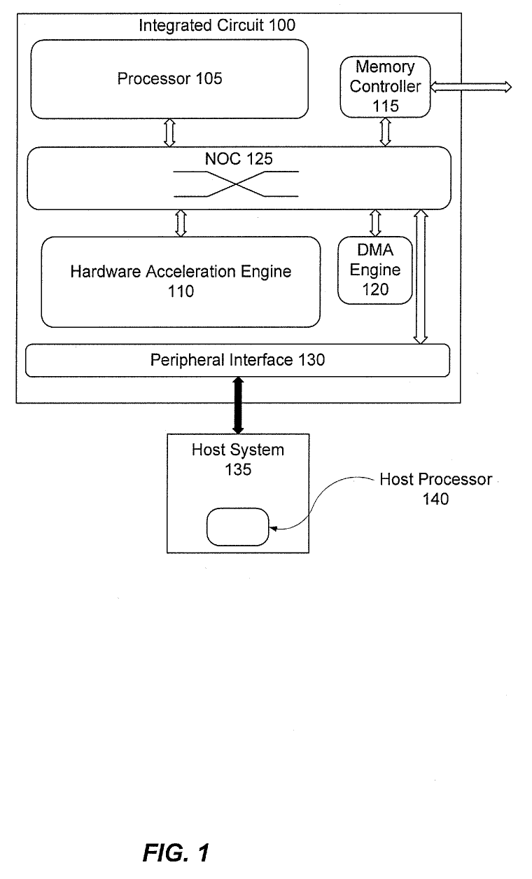

Hardware accelerators can be equipped with an integrated circuit (such as a System on a Chip (SoC) system) to provide software code running on a host processor 140 of a host system 135. For example, FIG. 1 illustrates a block diagram of an exemplary integrated circuit or hardware accelerator 100 having a processor 105 configured to communicate with a hardware acceleration engine 110 for offloading and acceleration of host processor 140. Integrated circuit 100 may also include, among other things, a memory controller 115, a Direct Memory Access (DMA) engine 120, a network on a chip (NoC) fabric 125, and a peripheral interface 130. Hardware acceleration engine 110 may communicate with processor 105, memory controller 115, and DMA engine 120 via NoC fabric 125. NoC fabric 125 communicates with the other components of host system 135 comprising host processor 140 via peripheral interface 130, such as peripheral component interconnect express (PCIe).

In general, demand on communication between code that runs on host processor 140 and code that runs on integrated circuit 100 can be extensive. For example, in integrated circuit 100 that provides offloading and acceleration for a virtual switch networking stack over the cloud, the controller code that runs on host processor 140 delivers configuration information such as access control list (ACL) rules to a control plane of networking that runs on processor 105 of integrated circuit 100. ACL rules may contain tens of thousands of entries and may be often times hundreds of megabytes in size. As stated above, conventional hardware accelerators are limited in that they are not suited to transfer large amounts of data in a timely, reliable, and efficient manner.

In contrast, the embodiments of the present disclosure provide an efficient communication channel between a host processor and a processor of an integrated circuit that allows for large amounts of data to be efficiently and reliably transferred in a timely manner.

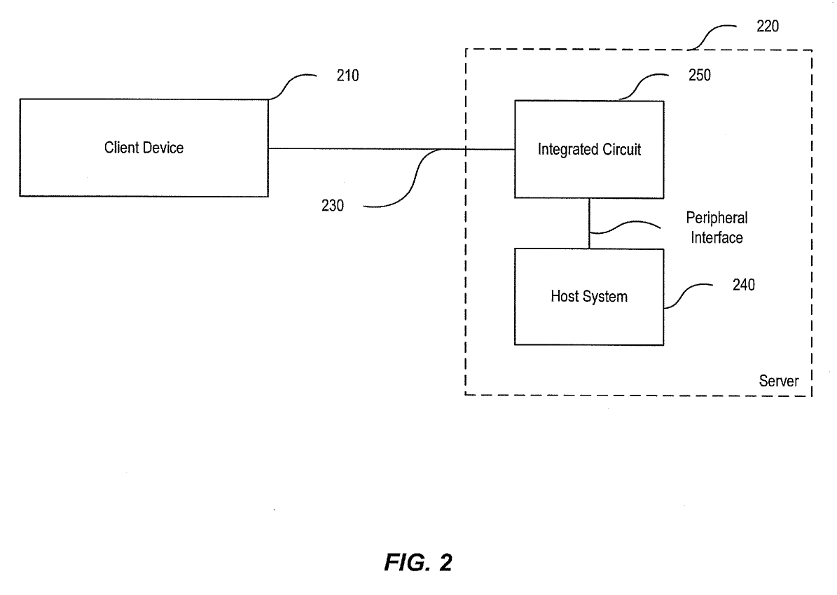

FIG. 2 is a schematic diagram of a client-server system that includes an exemplary integrated circuit in communication with an exemplary host system for efficiently and reliably transferring large amounts of data in a timely manner, consistent with embodiments of the present disclosure. Referring to FIG. 2, a client device 210 may connect to a server 220 through a communication channel 230, which may be secured. Server 220 includes a host system 240 and an integrated circuit 250. Host system 240 may include a web server, a cloud computing server, or the like. Integrated circuit 250 may be coupled to host system 240 through a connection interface, such as a peripheral interface. The peripheral interface may be based on a parallel interface (e.g., Peripheral Component Interconnect (PCI) interface), a serial interface (e.g., Peripheral Component Interconnect Express (PCIe) interface), etc. Integrated circuit 250 comprises a message forwarding engine for communicating large amounts of data more efficiently and reliably in a timely manner. In operation, server 220, providing host system 240 may be equipped with multiple integrated circuits 250, in order to achieve maximized performance.

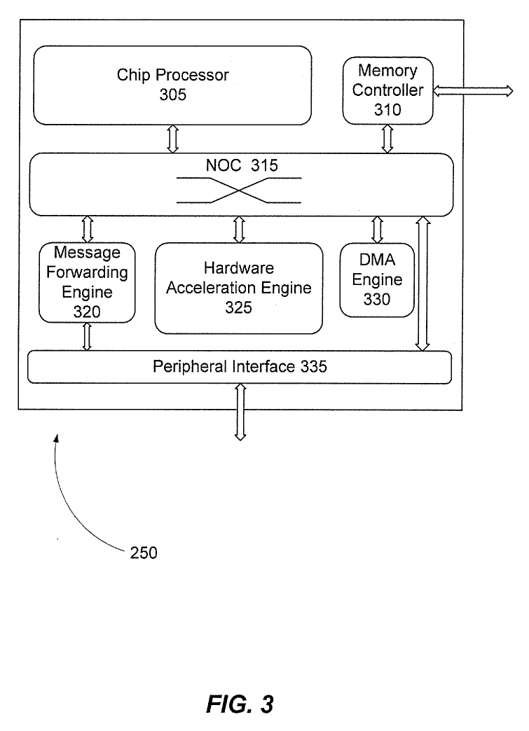

FIG. 3 illustrates a block diagram of integrated circuit 250 comprising a message forwarding engine 320, consistent with embodiments of the present disclosure. Referring to FIG. 3, integrated circuit 250 may be provided on a hardware computer peripheral card. For example, integrated circuit 250 may be soldered on or plugged in to a socket of the peripheral card. The peripheral card may include a hardware connector configured to be coupled with host system 240. For example, the peripheral card may be in the form of a PCI card, a PCIe card, etc., that is plugged onto a circuit board of host system 240.

Integrated circuit 250 may include a chip processor 305, a memory controller 310, a DMA engine 330, a hardware acceleration engine 325, Network-on-Chip (NoC) 315, a peripheral interface 335, and a message forwarding engine 320. These hardware components may be integrated into integrated circuit 250 as a single chip, or one or more of these hardware components may be in the form of independent hardware devices.

Chip processor 305 may be implemented as a Central Processing Unit (CPU) having one or more cores. Chip processor 305 may execute full-blown Operating System (OS) software such as Linux based OS software. The kernel of the OS software may include a network software stack such as a TCP/IP stack. The kernel of the OS software may also include a message layer software stack to communicate with host system 240.

Memory controller 310 may control local memories to facilitate the functionality of chip processor 305. For example, memory controller 310 may control access of data stored on memory units by chip processor 305. Memory controller 310 may also control memory locations associated with the integrated circuit 250 where data to be transmitted from a host system, for example host system 240, to the integrated circuit are stored for decapsulation and submission of the data to an application within a processor of integrated circuit 250.

DMA engine 330 may allow input/output devices to send or receive data directly to or from memory, thereby bypassing chip processor 305 to speed up memory operations.

Hardware acceleration engine 320 may offload code that is not performance optimal to run on host system 240 of server 220, thereby freeing up host system CPUs resources. Since the freed-up resources can be sold, for example to cloud customers, it is financially beneficial to cloud service providers. Further, the hardware acceleration engine 320 may be equipped with a CPU subsystem for providing software code running on the host system CPU.

NoC 315 may provide a high-speed on-chip interconnect that connects together the various hardware components on integrated circuit 250.

Peripheral interface 335 may include an implementation of a peripheral communication protocol such as PCIe protocol. For example, peripheral interface 335 may include a PCIe core to facilitate communication between integrated circuit 250 and host system 240 according to PCIe protocols.

Message forwarding engine 335 is responsible for receiving data from a host system CPU (not shown) and sending data to chip processor 305, in integrated circuit 250, and vice versa. Data that is transferred over message forwarding engine 310 can be packed in standard Ethernet packet format. Packets can be prepared and sent to and from the host processor and chip processor 305 in a manner similar to those applied by a socket interface, thereby simplifying the software programming model that leverages the message forwarding engine 310 and allowing the transfer of large amounts of data to be handled more efficiently and reliably. That is, communicating data packets via a TCP/IP protocol stack can assist with out of order packet delivery, congestion control, and rate control, to name a few.

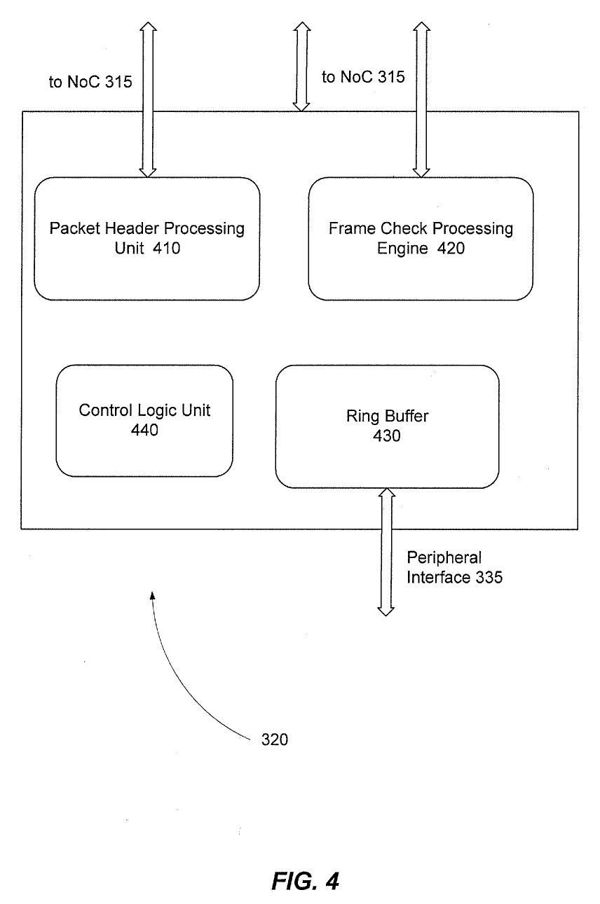

FIG. 4 illustrates a block diagram of an exemplary message forwarding engine 320, consistent with embodiments of the present disclosure. Message forwarding engine 320 can include a packet header processing unit 410, a frame check processing engine 420, and a ring buffer 430, and a control logic unit 440.

Packet header processing unit 410 is configured to handle header information of any received Ethernet packets from either the host processor or chip processor 305. Moreover, packet header processing unit 410 can augment the received Ethernet packet with additional header information. It is appreciated that the received Ethernet packet is encapsulated with the additional header information. The additional header information can include a field providing a forwarding indicator that indicates that information is being forwarded between the host processor and chip processor 305. The field can include any number of bits. With this additional header information, the packet receiving software that runs on the host processor and/or chip processor 305 of integrated circuit 250 can quickly distinguish these packets from other regular Ethernet packets that may be delivered to the receiving processor, and they can have the packet delivered to the application code that is intended to receive it. The additional header information can also be used to identify information for control purposes. For example, the additional header information may be used to track the path of a message from the host processor to the chip processor, and vice-versa. As illustrated in FIG. 4, packet header processing unit 410 can communicate with NoC 315.

Frame check processing engine 420 is configured to facilitate a frame check sequence calculation of the received Ethernet packet. For example, frame check processing engine 420 can generate a 16-bit one complement of the received packet. The frame check sequence can be attached to the received Ethernet packet (along with the additional header information) so that the receiving processor (whether it be the host processor or chip processor 305) can detect whether the data is accurate. Frame check processing engine 420 can also communicate with NoC 315.

Ring buffer 430 is configured to have a head pointer and a tail pointer, with the head pointer pointing to a latest packet received for transfer and the tail pointer pointing to a latest packet being sent. Ring buffer 430 is accessible to both the host processor and chip processor 305 of integrated circuit 250 via peripheral interface 335. Accordingly, ring buffer 430 can be internally divided into two virtual channels: One for host processor and another for chip processor 305. When ring buffer 430 becomes full, no more packets can be handled and a sender processor will stop sending and wait until an entry becomes available.

Control logic unit 440 is configured to provide congestion and rate control and can assist with controlling packet header processing unit 410, frame check processing engine 420, and ring buffer 430.

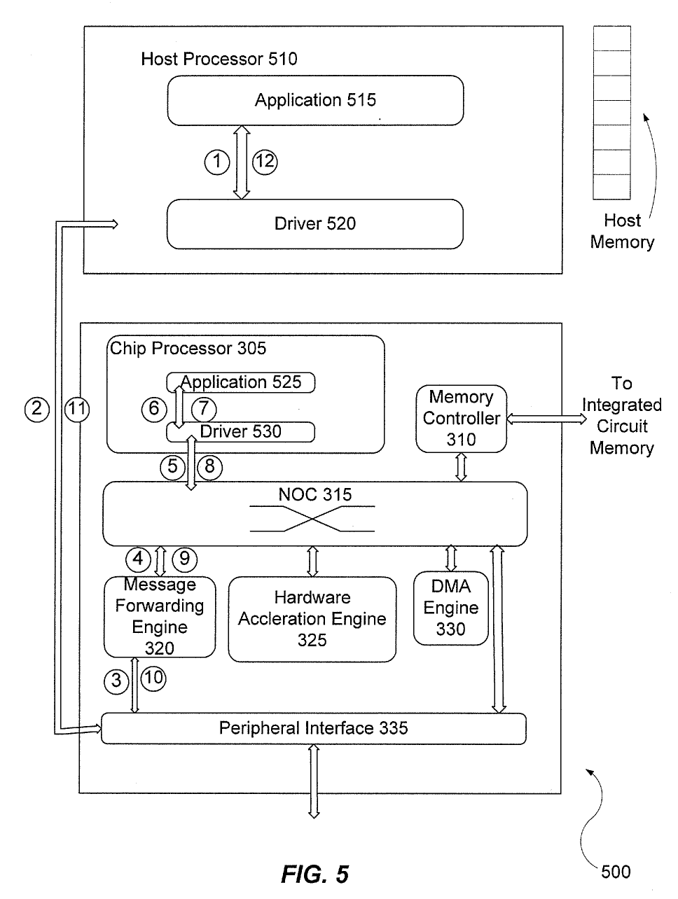

FIG. 5 illustrates a block diagram 500 of exemplary operational steps (1)-(12) between host processor 510 of host system 240 and chip processor 305 of integrated circuit 250, consistent with embodiments of the present disclosure. In this particular embodiment, host processor 510 acts as the sending processor by initiating a request with certain data and sending the data to chip processor 305 (i.e., the receiving processor). After receiving the request, chip processor 305 examines the request and then acts as the sending processor by providing a response back to host processor 510 (which now acts as the receiving processor). For example, the exemplary steps illustrated in FIG. 5 shows an application (e.g., an administrator) running on host processor 510 sending ACL rules to a networking control plane that runs on chip processor 305 of integrated circuit 250. Upon receiving the ACL rules, the control plane configures itself according to the ACL rules and responds to host processor 510 with an acknowledgement message.

At step 1, an application 515 (such as an administrator code) running on host processor 510 prepares one or more data packets to be sent. The data packet(s) is/are, for example, application-layer payload(s). In operation, the data packet(s) is/are copied by driver 520 to the host memory, when application 515 intends to invoke a device driver 530 associated with message forwarding engine 320.

At step 2, device driver 520 in the kernel space of host processor 510 calls kernel TCP/IP networking (not shown) to encapsulate the data packet(s) to create Ethernet packet(s). Device driver 520 initiates an Ethernet packet send procedure by writing an address of the Ethernet packet(s) to a ring buffer, for example ring buffer 430, in the message forwarding engine 320 over peripheral interface 335.

At step 3, message forwarding engine 320 receives the request via peripheral interface 335. After receiving the request, message forwarding engine 320 programs DMA engine 330 by sending DMA control commands to DMA engine 330 over NoC 315. Accordingly, a packet sent by host processor 510 is copied from the host processor's memory into the chip processor's memory for the message forwarding engine 320 to process.

After acquiring the packet, message forwarding engine 320 performs a frame check sequence procedure using, for example, frame check processing engine 420. Frame check processing engine 420 determines a frame check sequence (e.g., such as a checksum value or a cyclic redundancy check (CRC) value) of the original Ethernet packet and attaches the frame check sequence packet at the end.

After the frame check sequence is attached, message forwarding engine 320 encapsulates the packet with header information. For example, packet header processing unit 410 can encapsulate the packet by adding additional header information in front of the Ethernet packet. The additional header information can include a forwarding indicator, which indicates that the packet is being forwarded from the sending processor (in this case, host processor 510). Message forwarding engine 320 then copies the newly created packet (with the additional header information and the frame check sequence) into the memory of chip processor 305 and programs ring buffer 440.

At step 4, message forwarding engine 320 raises an interrupt to chip processor 305 via NoC 315.

At step 5, NoC 315 delivers the interrupt to chip processor 305. Device driver 530, which is associated with message forwarding engine 320 and running in chip processor 305, receives the interrupt, invokes a network packet receiving procedure in the kernel, and reads the packet from memory of integrated circuit 250. Device driver 530 can use memory controller 310 to facilitate the reading of the packet.

While reading the packet, device driver 530 can use a hook function in the packet receiving code in the kernel to examine the packet header. If the packet header includes the forwarding indicator (such as the additional header information) added by packet header processing unit 410, the packet is identified as being sent from host processor 510. Accordingly, after going through the TCP/IP stack processing and extracting the actual payload (the data packet at Step 1), a signal is delivered to the desired application, in this case, the networking control plane code.

At step 6, the application code is then scheduled to run in application 525. Application 525 receives the packet and handles it accordingly. In this illustrated example, application 525 programs the ACL rules sent from administrator application 515 on host processor 510 into its flow table and produces a response message.

At step 7 through step 12, the reverse of steps (1)-(6) is applied. That is, the response message, such as an acknowledgement of receipt of the ACL rules is encapsulated in an Ethernet packet and sent to the message forwarding engine 310, where the response message gets augmented with additional header information and delivered to the host processor 510.

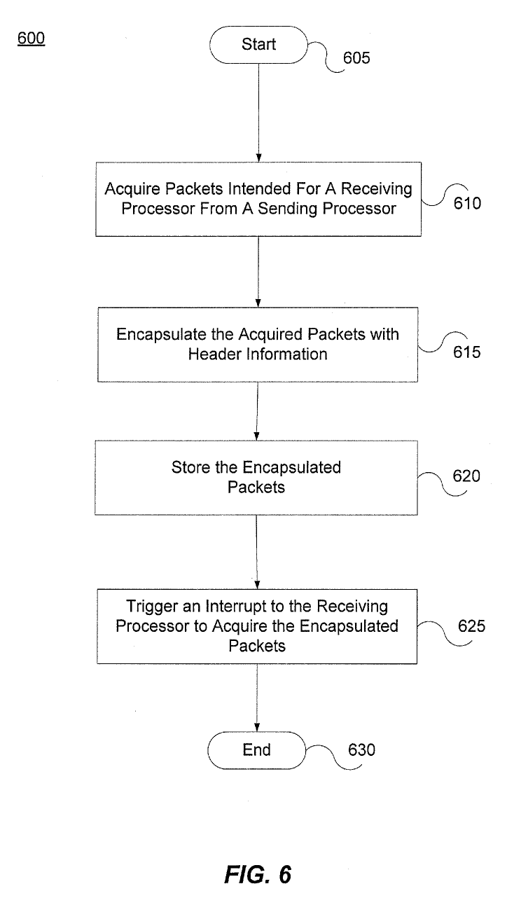

FIG. 6 illustrates a flowchart of an exemplary method 600 for acquiring and encapsulating data packets, consistent with embodiments of the present disclosure. Method 600 may be performed by a message forwarding engine (e.g., message forwarding engine 320) of an integrated circuit that has stored data packets received from a sending processor into memory. For this embodiment, it is appreciated that the sending processor can be a host processor (e.g., host processor 510), while a receiving processor can be a chip processor (e.g., chip processor 305). The data packets communicated between the sending and receiving processors can be, for example, an application-layer payload.

After initial start step 605, at step 610, data packets are acquired from the memory of the integrated circuit. For example, the message forwarding engine may access a ring buffer to call the appropriate data packets from the memory. It is appreciated that prior to the storing of the data packets in the memory of the integrated circuit, addresses of the data packets can be stored in the ring buffer, after which the data packets associated with the sending processor are copied to the memory of the integrated circuit. The message forwarding engine can prepare the data packets for sending to the receiving processor.

At step 615, the acquired data packets are encapsulated with header information. The header information can include a field indicating that information is being forwarded between the sending processor and the receiving processor. Besides the header information, a frame check sequence can be attached at the end, with the acquired data packet being the payload. At step 620, the encapsulated data packets are stored in a memory of the integrated circuit. For example, the message forwarding engine can copy the encapsulated data packet to the memory of the integrated circuit and program the ring buffer accordingly.

At step 625, an interrupt is triggered to the receiving processor to acquire the encapsulated packet. For example, the message forwarding engine raises an interrupt to the receiving processor, which is delivered via an NoC fabric (e.g., NoC fabric 315). Finally, the method ends at step 630.

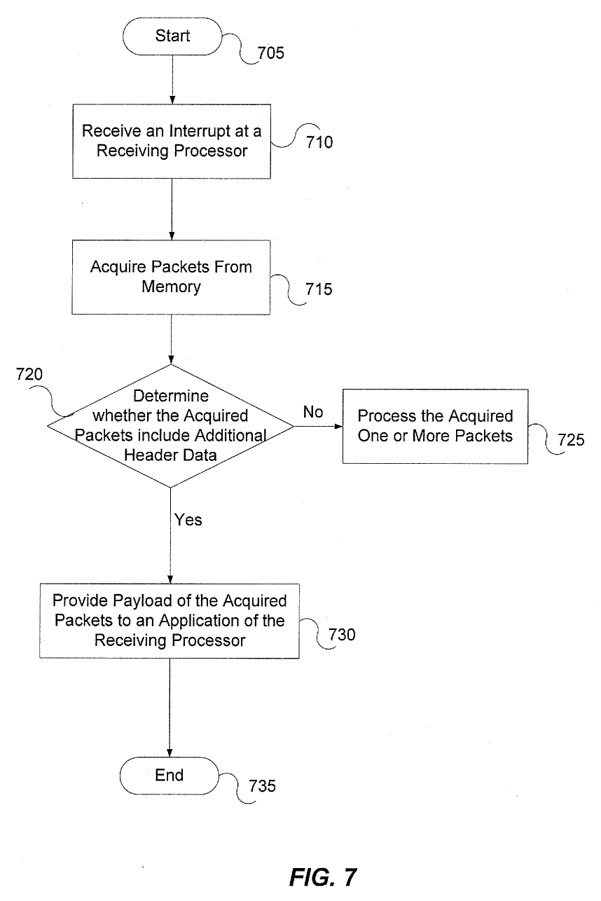

FIG. 7 illustrates a flowchart of an exemplary method for acquiring and decapsulating data packets, consistent with embodiments of the present disclosure. Method 700 can be performed by a receiving processor, which can be a host processor (e.g., host processor 510) or a chip processor (e.g., chip processor 305).

After initial start step 705, at step 710, an interrupt is received by the receiving processor. For example, a device driver (e.g., device driver 530) of the receiving processor receives the interrupt originating from a message forwarding engine (e.g., message forwarding engine 320). As noted above with respect to FIG. 6, the interrupt can be the triggered interrupt at step 625.

At step 715, the one or more packets are acquired from a memory of an integrated circuit. In particular, after receiving the interrupt, the device driver of the receiving processor invokes a network packet receiving procedure within the kernel to read the packet from the memory of the integrated circuit. As noted above with respect to FIG. 6, the acquired packets can be the stored encapsulated packets of step 620.

At step 720, a determination is made whether the acquired packets include additional header data indicating that data is being communicated from a sending processor to the receiving processor. For example, the receiving processor may include a hook function in the kernel to examine the packet header to determine if the header includes a field indicating that information is being forwarded from the sending processor to the receiving processor. If the additional header information is not found, at step 725, the receiving processor assumes that a “normal” packet has been received and processes the packet accordingly.

If, however, the additional header information is found, at step 730, the payload of the acquired packets is provided to an application of the receiving processor for processing. For example, when the field is found, the receiving processor confirms that information of the acquired data packets are being forwarded from the sending processor. Based on TCP/IP stack processing, the payloads of the acquired packets are extracted. The payloads can be the original packets provided by the sending processor, such as the packets acquired at step 610 of FIG. 6. These payloads are delivered to the application of the receiving processor for processing.

In some embodiments, the original packets can be evaluated using a frame check sequence attached to the end of the acquired data packets. If the frame check sequence is confirmed, the payloads can then be delivered to the application.

The method then proceeds to end at step 730.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

1. An integrated circuit comprising:
a chip processor;
a peripheral interface configured to communicate with a host system comprising a host processor; and
a message forwarding engine configured to acquire a data packet and to encapsulate the data packet with header information indicating that the acquired data packet is being communicated between the chip processor and the host processor.

2. The integrated circuit of claim 1 further comprising a memory configured to store the encapsulated data packet.

3. The integrated circuit of claim 1, wherein the message forwarding engine further comprises a frame check processing engine configured to determine a frame check sequence of the acquired data packet, wherein the frame check sequence is attached to the encapsulated data packet.

4. The integrated circuit of claim 3, wherein the encapsulated data packet includes:
a field of the header information, wherein the field indicates that the acquired data packet is being communicated between the chip processor and the host processor,
a payload having the acquired data packet, and
the frame check sequence after the payload.

5. The integrated circuit of claim 2, wherein the message forwarding engine is further configured to trigger an interrupt to the chip processor, wherein the interrupt is configured to cause a device driver of the chip processor to access the encapsulated data packet from the memory.

6. The integrated circuit of claim 1, wherein the chip processor is configured to determine whether the encapsulated data packet includes header information indicating that the acquired data packet is being communicated between the chip processor and the host processor.

7. The integrated circuit of claim 6, wherein the chip processor is further configured to decapsulate the encapsulated data packet when the encapsulated data packet includes the header information.

8. The integrated circuit of claim 1, wherein the message forwarding engine further comprises a ring buffer configured to:
receive, via the peripheral interface, an address of the data packet from a host system, wherein the address is used by the message forwarding engine to acquire the data packet from the host system.

9. The integrated circuit of claim 8, wherein the ring buffer is further configured to store an address within a memory where the encapsulated data packet is stored.

10. A server comprising:
a host system having a host processor; and
an integrated circuit comprising:
a chip processor;
a peripheral interface configured to communicate with the host processor; and
a message forwarding engine configured to acquire a data packet and to encapsulate the data packet with header information indicating that the acquired data packet is being communicated between the chip processor and the host processor.

11. The server of claim 10, wherein the message forwarding engine further comprises a frame check processing engine configured to determine a frame check sequence of the acquired data packet, wherein the frame check sequence is attached to the encapsulated data packet.

12. The server of claim 10, wherein the message forwarding engine further comprises a frame check processing engine configured to determine a frame check sequence of the acquired data packet, wherein the frame check sequence is attached to the encapsulated data packet.

13. The server of claim 10, wherein the chip processor is configured to determine whether the encapsulated data packet includes header information indicating that the acquired data packet is being communicated between the chip processor and the host processor.

14. The server of claim 13, wherein the chip processor is further configured to decapsulate the encapsulated data packet when the encapsulated data packet includes the header information.

15. The server of claim 10, wherein the message forwarding engine further comprises a ring buffer configured to:
receive, via the peripheral interface, an address of the data packet from a host system, wherein the address is used by the message forwarding engine to acquire the data packet from the host system.

16. The server of claim 15, wherein the ring buffer is further configured to store an address within a memory of the integrated circuit where the encapsulated data packet is stored.

17. A method performed by an integrated circuit having a chip processor and a memory, wherein the integrated circuit is communicatively coupled to a host system having a host processor, the method comprising:
acquiring, from a sending processor, one or more data packets intended for a receiving processor, wherein the sending processor is one of the chip processor and the host processor and the receiving processor is the other of the chip processor and the host processor;
encapsulating the one or more acquired data packets with header information indicating that the acquired data packet is being communicated between the chip processor and the host processor;
storing the one or more encapsulated data packets in the memory of the integrated circuit; and
delivering an interrupt to the receiving processor, wherein the interrupt provides information that causes the receiving processor to acquire the encapsulated one or more data packets from the memory.

18. The method of claim 17, wherein the one or more encapsulated data packets includes a frame check sequence for verifying the acquired data packet.

19. A method performed by a receiving processor that is one of host processor of a host system and a chip processor of an integrated circuit that is communicatively coupled to the host system, the method comprising:
acquiring one or more data packets from a memory of the integrated circuit;
determining whether the one or more acquired data packets includes additional header information indicating that the acquired data packet is being communicated between the host processor and the chip processor;
decapsulating the header information of the one or more data packets in response to the one or more acquired data packets having the additional header information; and
processing the payload of the one or more acquired data packets.

20. The method of claim 19, further comprising:
prior to acquiring the one or more data packets, receiving an interrupt configured to cause the receiving processor to call for the one or more data packets from the memory.

21. The method of claim 19, wherein processing the payload of the one or more acquired data packets occurs when a frame check sequence corresponds to the payload of the one or more acquired data packets.
